(19) United States
(12) Patent Application Publication
(10) Pub. No.: US 2017/0019543 A1
(43) Pub. Date: Jan. 19, 2017

(54) Scan Through Display and Methods of Using Same

(71) Applicant: Lexmark International, Inc., Lexington, KY (US)

(72) Inventors: Masahito Cho, Lexington, KY (US); Peter Joseph Mendel, Lexington, KY (US); Robert Henry Muyskens, Lexington, KY (US); Adam Randal Wiedemann, Lexington, KY (US)

(21) Appl. No.: 14/800,086

(22) Filed: Jul. 15, 2015

(51) Int. Cl. H04N 1/00; H04N 1/10; H04N 1/028; H04N 1/195

(52) U.S. Cl. CPC H04N 1/00129; H04N 1/19594; H04N 1/1065; H04N 1/02895; H04N 2201/0081; H04N 2201/0089

(57) ABSTRACT

An imaging device, including a panel having a privacy layer selectively configurable in a transparent state and an opaque state that blocks light from passing through the panel, and a display layer made of transparent material and positioned between the privacy layer and an outer surface of the panel, the display layer spaced from the privacy layer. A scanning device is disposed proximate to a surface of the privacy layer opposite the outer surface of the panel, for scanning an object positioned along the outer surface of the panel, wherein the controller operates the privacy layer in the transparent state and the display layer to not display image data in at least a first portion of panel such that the first portion thereof is transparent during the scanning operation for scanning the object.

### CROSS REFERENCES TO RELATED APPLICATIONS

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure is related to a device for scanning sheets of media, and particularly to an apparatus and process for capturing images appearing on media sheets.

2. Description of the Related Art

Conventional scanning devices are used to generate digital representations of documents being scanned. In one type of scanning device, typically known in the art as a flat bed scanner, prior to scanning of a target document, the scanner lid is lifted and the target document is positioned on a document glass in the correct orientation and location. Thereafter, prior to scanning, the scanner lid is closed to prevent incident light around the edges of the target document from adversely affecting the quality of the scan.

Recent advances in scanning devices include improvements made to the user interface. These improvements include improvements to both the structure and firmware features of scanning devices. For instance, U.S. Pat. Nos. 8,045,240, 8,194,292 and 8,243,318, which are assigned to the assignee of the present application, are generally directed to the use of a liquid crystal display (LCD) as part of or otherwise associated with the scan bed platen of a scanning device. Utilizing an LCD as part of the scan bed platen advantageously allows for information to be displayed using the LCD to simplify the scan operation from the perspective of the user and, in doing so, improve user experience.

### SUMMARY

Example embodiments of the present disclosure further improve upon the current state of the art of scanning devices. According to one example embodiment, there is shown an imaging device including a panel having: a privacy layer selectively configurable in a transparent state in which light passes through the privacy layer, and an opaque state in which a sufficient amount of light, such as some or all of the light entering the privacy layer, is obscured so that objects behind the panel are not clearly visible; and a display layer made of transparent material and positioned between the privacy layer and an outer surface of the panel, the display layer being spaced from the privacy layer. The imaging device further includes a controller communicatively coupled to the panel for controlling the privacy layer and the display layer in a plurality of operational modes and a scanning device proximate to a surface of the privacy layer opposite the outer surface of the panel. The controller is communicatively coupled to the scanning device for scanning an object positioned along the outer surface of the panel and capturing an image corresponding to the object. One of the plurality of operational modes is a first display mode in which the controller operates the privacy layer to be in the opaque state and the display layer to display image data. Another of the plurality of operational modes is a mode in which the controller operates the privacy layer in the transparent state and the display layer to not display image data in at least a portion of the display layer such that the portion is transparent for the scanning operation.

In an example embodiment, the scanning device includes a movable scan head or camera scan components for capturing an entire image at one time. In still another embodiment, the scanning device includes a projector disposed along one side of the imaging device, a camera unit disposed along an opposite side of the imaging device, and one or more prisms positioned between and in optical communication with the projector and the camera unit. The projector, the one or more prisms and the panel form a first optical light path from the projector, through the one or more prisms and through the panel to reach the object. The panel, the one or more prisms and the camera unit form a second optical light path for light reflected by the object to pass through the panel and reflect from the one or more prisms for capture by the camera unit. The projector and the camera unit are communicatively coupled to the controller.

In another example embodiment, the imaging device may include the panel and the controller but without the scanning device, and finds use in non-scanning applications, such as a storefront window replacement.

### BRIEF DESCRIPTION OF THE DRAWINGS

The above-mentioned and other features and advantages of the disclosed embodiments, and the manner of attaining them, will become more apparent and will be better understood by reference to the following description of the disclosed embodiments in conjunction with the accompanying drawings, wherein:

FIG. 1 is cross sectional view of an imaging device according to an example embodiment;

FIG. 2-4 are top or front views of a panel of the imaging device of FIG. 1 illustrating various operational modes thereof;

FIGS. 5-7 are top/front and cross sectional views of portions of the imaging device of FIG. 1 during a scan operation;

FIGS. 8A and 8B are cross sectional views of an imaging device according to additional example embodiments; and

FIG. 9 is a cross sectional view of the imaging device according to an additional example embodiment.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Spatially relative terms such as “top,” “bottom,” “front,” “back” and “side,” “above,” “under,” “below,” “lower,” “over,” “upper,” and the like, are used for ease of description to explain the positioning of one element relative to a second element. Terms such as “first,” “second,” and the like, are used to describe various elements, regions, sections, etc. and are not intended to be limiting. Further, the terms “a” and “an” herein do not denote a limitation of quantity, but rather denote the presence of at least one of the referenced item.

Furthermore, and as described in subsequent paragraphs, the specific configurations illustrated in the drawings are intended to exemplify embodiments of the disclosure and that other alternative configurations are possible.

Reference will now be made in detail to the example embodiments, as illustrated in the accompanying drawings. Whenever possible, the same reference numerals will be used throughout the drawings to refer to the same or like parts.

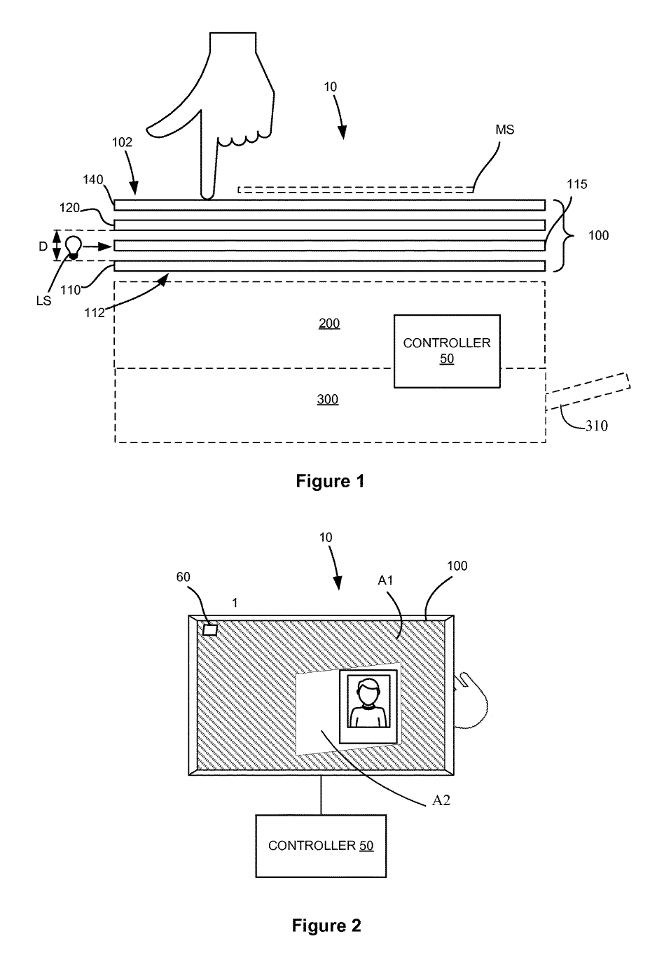

FIG. 1 generally shows an imaging device 10 which is suited to perform one or more imaging operations. In an example embodiment, imaging device 10 is or includes a scanning device 200 for capturing an image appearing on one or more sheets of media. It is understood, though, that imaging device 10 may perform other imaging based operations in addition to or in the alternative to an image scanning operation. In addition, imaging device 10 may include printing device 300 which prints images on sheets of media. In an example embodiment, printing device 300 utilizes electrophotographic processes to print toner images onto media sheets. Electrophotographic printing devices are well known in the art such that a detailed description thereof will not be provided for reasons of simplicity. Scanning operations will be described herein with respect to scanning sheets of media but it is understood that scanning device 200 may be used to scan objects other than sheets of media.

Imaging device 10 includes a panel 100 for displaying image data and facilitating one or more other imaging operations. As shown in FIG. 1, panel 100 includes a privacy layer 110 selectively switchable between a transparent state in which light passes therethrough, and an opaque state that blocks at least some light from passing through panel 100 so that privacy layer 110 has a frosted appearance and objects behind the panel are obscured and not clearly visible. Controlling privacy layer 110 allows for presenting a frosted appearance over a least a portion of panel 100 and, when in the transparent state, for passing light to an outer surface 102 of panel 100. Panel 100 also includes a display layer 120 positioned between privacy layer 110 and an outer surface 102 of panel 100. Display layer 120 is spaced by a distance D from privacy layer 110. Display layer 120 may be formed from an ambient Organic LED (OLED) layer, a passive LCD layer or the like for generating an image to be displayed by panel 100 to a user/viewer of imaging device 10, and for providing a transparent layer otherwise. Panel 100 may further include a touch screen layer 140 disposed on display layer 120 to receive user information from contact for controlling display layer 120, for example.

Panel 100 further includes a light guide layer 160 that is disposed between privacy layer 110 and display layer 120. Light guide layer 160 may be an air space or other light conductive medium, such as glass or plastic. A light source LS, which may be an array of light emitting diodes (LEDs), is optically coupled to the light guide layer 160 so as to provide a controlled backlit region for display layer 120. For example, injecting light from controllable light source LS into light guide layer 160 creates a brightness adjustable backlight region.

In an example embodiment, touch screen layer 140, display layer 120 and privacy layer 110 are adhered together as a single laminate panel 100.

Scanning device 200 may be a traditional, flat bed scanning device having a movable scan head which captures image portions as the scan head moves underneath an image. In this embodiment, panel 100 forms the platen of scanning device 200 onto which to-be-scanned sheets of media may be placed. Flat bed scanning devices are well known in the art such that a detailed description will not be presented for reasons of simplicity. Instead of capturing portions of an image at a time, in an alternative example embodiment, scanning device 200 may capture the entire image in one operation. Such a capture device is described in a number of patents and patent applications assigned to the assignee of the present application, including U.S. Pat. Nos. 8,559,074, 8,755,627, and 896,890; and U.S. patent applications 2011/0122460 and 2011/0122465, the content of each being hereby incorporated by reference herein in its entirety.

Imaging device 10 includes a controller 50 communicatively coupled to light source LS and panel 100 for configuring privacy layer 110 in transparent and opaque states, and for providing data, such as still image data and/or video data, to display layer 120 for displaying same. Controller 50 is also coupled to scanning device 200 for initiating an image capture operation. In an example embodiment, controller 50 configures panel 100 in a number of operational modes.

One operational mode of panel 100 is a first display mode in which privacy layer 110 is configured in the opaque state so as to provide no visibility through panel 100, and display layer 120 is configured to display image data that is provided to display layer 120 by controller 50. In the first display mode, the image data displayed may be any data relating to an imaging operation of imaging device 10. For example, FIG. 2 shows an external front or top view of panel 100 configured in the first display mode, with area A1 being opaque using privacy layer 110 as controlled by controller 50, and image area A2 providing data using display layer 120 as controlled by controller 50. The images provided by area A2 may include, for example, an image captured from a recently scanned media sheet or the visual display of a user interface for operating imaging device 10. The depiction of a hand in FIGS. 2-5 is not part of imaging device 10 and instead is intended to indicate areas of panel 100 that are opaque and transparent.

It is understood that the size and location of area A2 may vary depending on any number of factors, including user preference, and that area A2 may be spawned in response to any one of a number of events. For example, panel 100 may display icon 60, which when activated (via touch screen layer 140 or otherwise) spawns area A2 on panel 100 for displaying the user interface of imaging device 10.

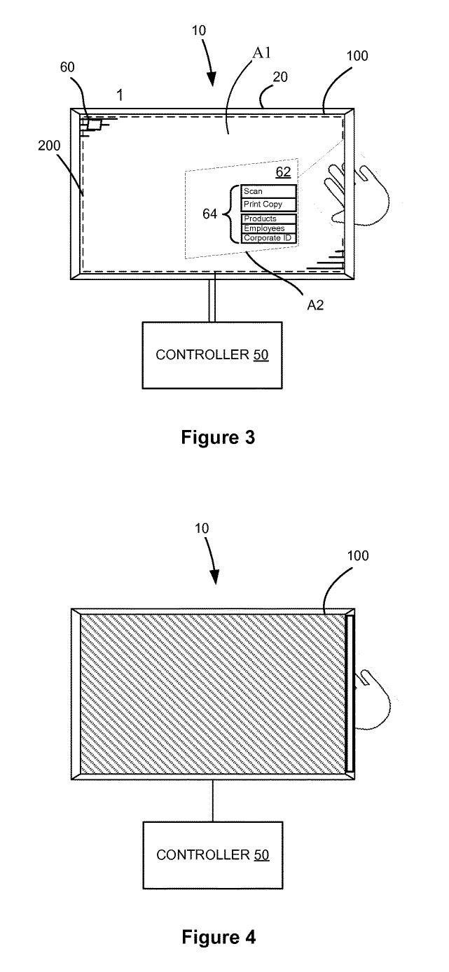

Another operational mode of panel 100 is a second display mode in which controller 50 configures privacy layer 110 in a transparent state and configures display layer 120 to display image data, provided by controller 50, to a user. As with the first display mode, the image data displayed in the second display mode may be any data relating to an operation of imaging device 10, including an image captured by scanning device 200 and user interface information. FIG. 3 shows an external front view of panel 100 configured in the second display mode, with area A1 being transparent using privacy layer 110 as controlled by controller 50, and image area A2 also being transparent but in addition providing data using display layer 120 as controlled by controller 50. Area A2 may, for example, display part of the user interface for imaging device 10, including user-selectable function tabs 64 which a user may select by touching touch screen layer 140. Panel 100 being largely transparent allows for visibility through panel 100.

According to an example embodiment, controller 50 configures panel 100 in a third display mode in which privacy layer 100 is configured in the opaque state and display layer 120 so that no data is displayed. FIG. 4 depicts panel 100 in the third display mode. Panel 100 may be configured by controller 50 in a fourth display mode in which privacy layer 110 is controlled to be transparent and controller 50 provides no data to be displayed by display layer 120.

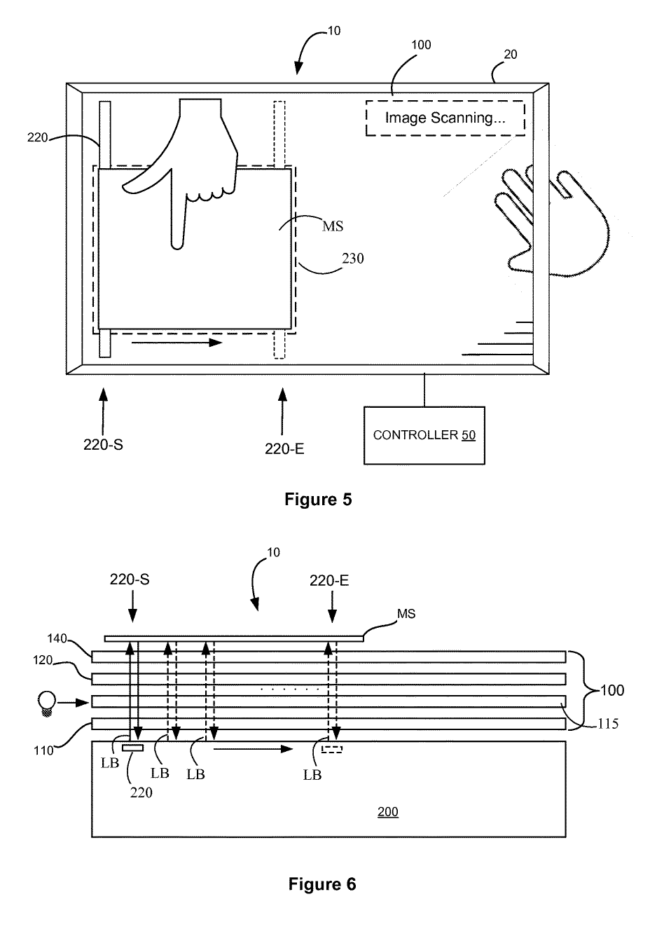

With reference again to FIG. 3, panel 100 may be configured in the second or fourth display mode during a scan operation. Specifically, privacy layer 110 may be controlled by controller 50 to be transparent so as to allow scanning device 200 to direct light to a sheet of media placed on panel 100 and to pass reflected light therefrom for capture, Imaging device 10 performing a scan operation will be described with reference to FIGS. 5-7.

In FIG. 5, controller 50 initially controls panel 100 in the second display mode with privacy layer configured in the transparent state and display layer 120 to display no image data in at least a portion of panel 100 that is adjacent to media sheet MS so that light passes uninterruptedly through panel 100. Alternatively, panel 100 is controlled in the fourth display mode such that no data is displayed by display layer 120. With panel 100 being configured in the second display mode, the interior of imaging device 10, and particularly scanning device 200, is visible. In FIG. 5, scanning device 200 is shown including a scan bar 220 for scanning media sheet MS. During the scanning operation, scan bar 220 moves from a start position 220-S to an end position 220-E, illuminating the bottom side of media sheet MS and capturing the light reflected (hereby. In this example embodiment, the start position 220-S is disposed at a left portion 100 of panel 100 and the end position 220-E is disposed at a central portion 100 of panel 100 (as viewed in FIG. 5), but it is understood that scan bar 200 may have different start and end positions. In one example embodiment, during the scanning operation, display layer 120 may be controlled by controller 50 to display “Image Scanning . . . ” to indicate to a user that the scanning operation is in progress.

Start position 220-S and end position 220-F, may be determined by imaging device 10 based at least upon knowledge of the size of media sheet MS to be scanned. In addition, display layer 120 may be controlled to display a target area 230 on panel 100 for assisting the user with placing media sheet MS in the correct location on panel 100 for the scan operation. In an alternative embodiment, controller 50 controls privacy layer 110 or display layer 120 to make opaque all of panel 100 except for the area within target area 230.

FIG. 6 illustrates a cross sectional view of imaging device 10 during a scan operation. Light, illustrated as light beams LB, is generated by scan bar 200 as scan bar 200 moves from start position 220-S to end position 220-E. With privacy layer 110 configured in the transparent state and display layer 120 not displaying data (or at least in the area of panel 100 covered by scan bar 220), light beams LB are able to pass through panel 100, generally in the direction from scan bar 200 of scanning device 200 to media sheet MS, and light reflected by media sheet MS is able to pass through panel 100 generally in the direction from media sheet MS to scan bar 22.0 in scanning device 200 for capture by the photosensors on scan bar 220. In this way, the image appearing on media sheet MS is effectively captured by scanning device 200.

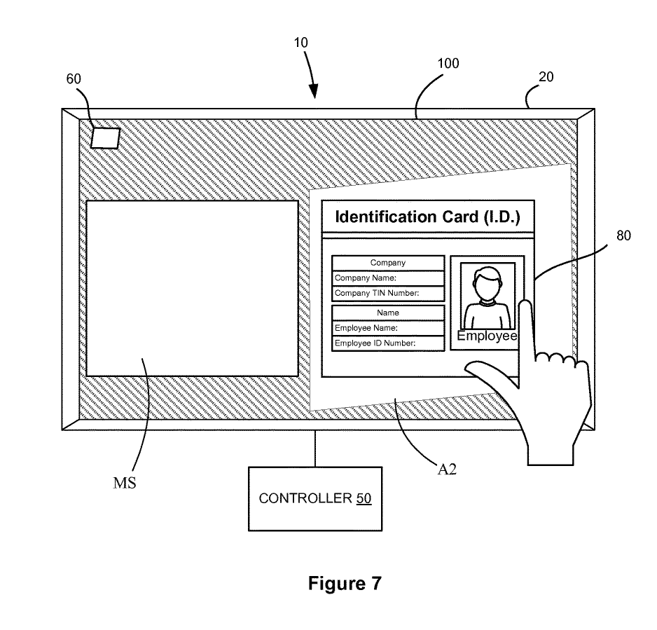

According to an example embodiment, immediately following image capture, panel 100 is placed in the first display mode in which privacy layer 110 is configured to be opaque and controller 50 provides the captured image to display layer 120 for display at full scale as part of the user interface of imaging device 10, as shown in FIG. 7. Specifically, controller 50 provides to display layer 120 the captured image 80. With the captured image 80 displayed, the user may manipulate touch screen layer 140 to change the magnification of captured image 80 and edit the image.

In the event the scanning operation involves scanning a number of media sheets, the user interface of imaging device 10 may allow for multiple captured images to be displayed on panel 100, either simultaneously or sequentially, and allow for the user to change the size and shape of area A2 for facilitating the display of the captured images.

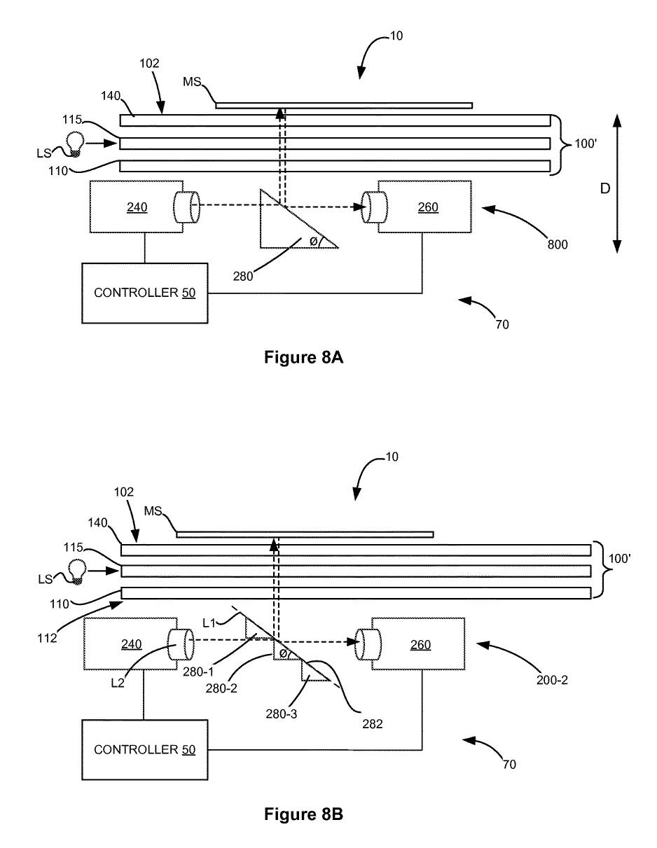

In the example embodiment of FIGS. 8A and 8B, imaging device 10 performs various imaging operations including a scan function. Specifically, imaging device 10 of FIGS. 8A and 813 uses panel 100′ that includes at least some of the layers found in panel 100 of the embodiment of FIGS. 1-7. Instead of display layer 120, imaging device 10 of FIGS. 8A and 8B uses a projector 240 disposed underneath (as viewed from the perspective of FIGS. 8A and 8B) and adjacent privacy layer surface 110, for providing data for display on panel 100′. Projector 240 is also used during a scan operation in projecting light towards a media sheet disposed on panel 100′. Imaging device 10 of FIGS. 8A and 8B further includes a camera unit 260 disposed beneath privacy layer 110. Camera unit 260 is adapted to capture light during a scan operation that is initially projected by projector 240 and reflected from media sheet MS disposed on panel 100′. It is noted that each of projector 240 and camera unit 260 is oriented in or otherwise facing a direction that is orthogonal to the direction to panel 110′. In the example embodiment of FIGS. 8A and 8B, projector 240 and camera unit 260 face each other.

Imaging device 10 of FIG. 8A further includes a prism 280 positioned between projector 240 and camera unit 260 and underneath panel 100′. Wedge shaped prism 280 serves to refract light from projector 240 towards the outer surface of panel 100′ and to reflect light from media sheet MS towards camera unit 260. The surface facing projector 240 is perpendicular thereto. Prism 280 thus allows for both projector 240 and camera unit 260 to be disposed substantially close to panel 110′ so that the depth D, seen from the top of panel 110′ to the bottom of projector 240 and camera unit 26 in FIG. 8A, is relatively small. In order to reduce the distance D, prism 280 is chosen to have a relatively high index of refraction.

According to the example embodiment, the ratio of the index of refraction of prism 280 and the index of refraction of air within imaging device 10 is set to a value to direct the light shining into the hack (or left side, as viewed in FIG. 8A) of prism 280 from projector 240 towards panel 100′. The reflective nature of prism 280 also serves to direct light originating from panel 100′ to reflect from prism 280 into camera unit 260.

Prism 280 may be constructed from silicon and have an index of refraction of about 3.96. With an index of refraction of about 3.96, angle ø of prism 280 may be as low as about 14 degrees, such as 14.17 degrees. For panel 100′ being 42 inches along the diagonal, the height of prism 280 is about 5.2 inches.

In this example embodiment, projector 240 and camera unit 260 are communicatively coupled to controller 50 such that during a scan operation, projector 240 projects light which is refracted by prism 280 towards media sheet MS disposed on the top of panel 100′. Similar to the prior embodiments, privacy layer 110 is configured to be transparent so that the light from projector 240 reaches the media sheet. The light reflected by media sheet MS is reflected by the surface of prism 280 and collected by camera unit 260. With the image captured by camera unit 260, controller 50 is then capable of providing the captured image to projector 240 for projection onto panel 110′ for viewing, Privacy layer 110 may be configured to be opaque during the time the captured image is projected on panel 100′.

Because the cost of silicon crystal is relatively high, in another embodiment, illustrated in FIG. 8B, prism 280 is replaced with an array of wedge shaped prisms 280-1 to 280-n. The array of prisms 280-1 to 280-n is arranged along a line L1. Each of prisms 280-1 to 280-n maintains the perpendicular surface facing projector 240, and maintains the same angle ø between the reflective surface of prism 280-1 to 280-n relative to camera unit 260 and panel 110′ as the angle ø in the embodiment of FIG. 8A. Replacing prism 280 of FIG. 8A with the array of prisms 280-1 to 280-n, the total volume of silicon is substantially reduced while maintaining the wedge optical properties of prism 280.

With reference again to prism 280 of FIG. 8A and prism array 280-1 to 280-n of FIG. 8B, the reflective loss thereof can be relatively high for the silicon material having a relatively high index of refraction. For passing light from air to the silicon prism 280, with a reflectivity of about 35.6%, the transmissivity of light passing from air to the silicon prism 280 is about 64.4%. In order to reduce the reflective loss from potentially two reflective barriers—a first from projector 240 (air) to prism 280, and a second from prism 280 back to air—one approach is to directly connect projector 240 to prism 280 and prism arrangement 280-1 to 280-n. This direct connection results in reducing the loss to a single air/silicon interface.

In another embodiment, camera unit 260 and prism 280 (or prism array 280-1 to 280-n) are used with panel 100 of FIG. 1, without projector 240, in this embodiment, display layer 120, as controlled by controller 50, allows for data to be displayed on panel 100 and light source LS provides light for use in a scan operation.

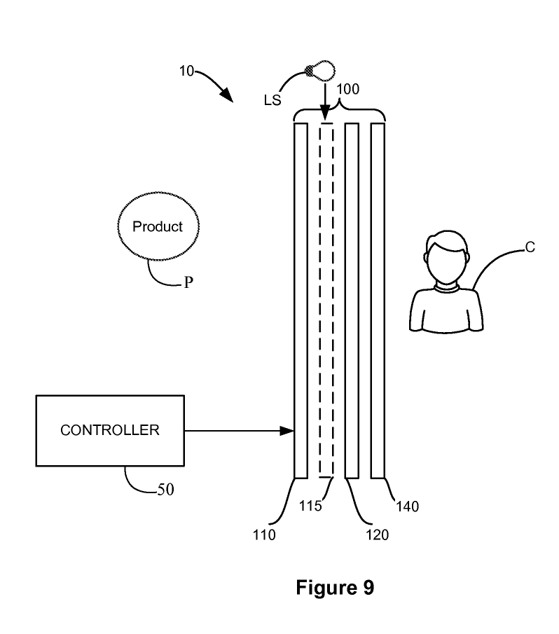

Panel 100 has been described as part of imaging device 10 which performs various imaging functions, such as a scanning function. It is understood that panel 100 may be used independently of a scanning device. For example, panel 100 may replace the glass in a storefront window. FIG. 9 depicts a window embodiment of imaging device 10. In the example embodiment, controller 50 is coupled to panel 100 and light source LS. As with the embodiment of FIG. 1, panel 100 is configurable in the first, second, third and fourth display modes as described above. In this embodiment, controller 50 may configure panel 100 in the first display mode if, for example, only data (e.g., information pertaining to product P) is desired to be provided to customer C. Controller 50 may configure panel 100 in the second display mode if, for example, it is desired to make product P visible to customer C and to display additional data (e.g., information about product P). Controller 50 may configure panel 100 in the fourth display mode if, for example, it is desired to only make product P visible to customer C. The third display mode may be utilized if, for example, neither product P nor data is desired to be presented to customer C. Touch screen 140 may be used by customer C to, for example, control the information customer C wishes to view.

The foregoing description of several methods and an embodiment of the invention have been presented for purposes of illustration. It is not intended to be exhaustive or to limit the invention to the precise steps and/or forms disclosed, and obviously many modifications and variations are possible in light of the above teaching. It is intended that scope of the invention be defined by the claims appended hereto.

What is claimed is:

We claim:

1. An imaging device, comprising:
a panel including:
a privacy layer selectively configurable in a transparent state and an opaque state; and
a display layer made of transparent material and positioned between the privacy layer and an outer surface of the panel, the display layer spaced from the privacy layer; and
a controller communicatively coupled to the panel for controlling the privacy layer and the display layer in a plurality of operational modes, one of the operational modes being a first display mode in which the privacy layer is configured in the opaque state to provide no visibility through the panel and the display layer is configured to display image data provided to the display layer by the controller.

2. The imaging device of claim 1, wherein another of the plurality of operational modes comprises a display mode in which the controller configures the privacy layer in the opaque state and the display layer to display no image data.

3. The imaging device of claim 1, wherein another of the plurality of operational modes comprises a second display mode in which the controller configures the privacy layer in the transparent state and the display layer to display the image data provided by the controller to the display layer, at least portions of the panel not having the image data displayed are transparent for visibility through the panel.

4. The imaging device of claim 1, wherein the panel further comprises a touch screen layer communicatively coupled to the controller and disposed on the display layer to receive information from contact for controlling the display layer by the controller based at least in part upon the information received.

5. The imaging device of claim 1, wherein the panel further comprises a light guide layer that is disposed between the privacy layer and the display layer, and a light source communicatively coupled to the light guide layer to provide a controlled backlit region for the display layer.

6. The imaging device of claim 1, further comprising a scanning device proximate to a surface of the privacy layer, wherein the controller is communicatively coupled to the scanning device for scanning an object positioned along the outer surface of the panel, the scanning device capturing an image corresponding to the object during a scanning operation, wherein another of the plurality of operational modes is a mode in which the controller operates the privacy layer in the transparent state and operates the display layer to display no image data to allow light to pass through the panel during the scanning operation.

7. The imaging device of claim 6, wherein following the scanning device capturing the image, the controller configures the panel in the first display mode in which the image data provided to the display layer corresponds to the captured image.

8. The imaging device of claim 6, wherein the scanning device includes a camera unit and one or more prisms positioned between and in optical communication with the camera unit and the panel, the camera unit communicatively coupled to the controller such that during the scanning operation, the camera unit captures the image corresponding to the object and the captured image is provided by the controller to the display layer which displays the image data.

9. The imaging device of claim 8, wherein the one or more prisms comprises a plurality of prism wedges arranged to form a reflective surface disposed at an angle to reflect an image from the object towards the camera unit for capture thereby.

10. An imaging device, comprising:
a panel including a privacy layer selectively configurable in a transparent state and an opaque state that blocks light from passing through the panel;
a controller communicatively coupled to the panel for controlling the panel in a plurality of operational modes; and
a scanning device proximate to a surface of the privacy layer opposite the outer surface of the panel, wherein the controller is communicatively coupled to the scanning device for scanning an object positioned along the outer surface of the panel, the scanning device receiving and capturing an image corresponding to the object during a scanning operation, wherein the scanning device comprises a projector disposed along one side of the imaging device, a camera unit disposed along an opposite side of the imaging device at a similar elevation as the projector in the imaging device, and one or more prisms positioned between the projector and the camera unit adjacent the panel, wherein the projector, the one or more prisms and the panel form a first optical light path from the projector, through the one or more prisms and through the panel to reach the object, wherein the panel, the one or more prisms and the camera unit form a second optical light path for light reflected by the object to pass through the panel, reflect from the one or more prisms for capture by the camera unit, and wherein the projector and the camera unit are communicatively coupled to the controller;
wherein one of the plurality of operational modes is a mode in which the controller operates the privacy layer in the transparent state during the scanning operation in which an image of the object is captured by the camera unit.

11. The imaging device of claim 10, wherein another of the plurality of operational modes comprises a first display mode in which the privacy layer is configured in the opaque state to provide no visibility through the panel and the projector is controlled by the controller to project an image on a back surface of the privacy layer.

12. The imaging device of claim 11, wherein following the scanning operation, the controller configures the panel in the first display mode, the image data displayed on the display layer comprises the captured image corresponding to the object, and the panel provides no visibility of an interior of the imaging device.

13. The imaging device of claim 10, wherein another of the plurality of operational modes comprises a privacy mode in which the controller configures the privacy layer in the opaque state so that the panel appears frosted with no visibility therethrough and configures the projector to display no image data.

14. The imaging device of claim 10, wherein the panel further comprises a touch screen layer communicatively coupled to the controller to receive information from contact, the touch screen layer providing at least part of a user interface for the imaging device.

15. The imaging device of claim 14, wherein another of the plurality of operational modes comprises a display mode in which the privacy layer is configured in the opaque state to provide no visibility through the panel and the projector is configured to project image data provided by the controller to a surface of the privacy layer.

16. The imaging device of claim 10, wherein the one or more prisms comprises a plurality of prism wedges arranged to collectively form a first surface disposed at an acute angle relative to a line orthogonal to the panel, the image received by the camera unit during the scanning operation reflecting off of the first surface towards the camera unit for capture thereby.

17. An apparatus, comprising:
a panel including:
a privacy layer selectively configurable in a transparent state and an opaque state that blocks light from passing through the panel; and
a display layer made of transparent material and positioned between the privacy layer and an outer surface of the panel, the display layer spaced from the privacy layer; and
a controller communicatively coupled to the panel for controlling the privacy layer and the display layer in a plurality of operational modes, the operational modes comprising a first mode in which the privacy layer is configured in the opaque state to provide no visibility through the panel and the display layer is configured to display image data provided to the display layer by the controller, and a second mode in which the privacy layer is configured in the transparent state to provide visibility through the panel and the display layer is configured to display image data provided to the display layer by the controller.

18. The apparatus of claim 17, wherein the plurality of operational modes comprise a third mode in which the controller configures the privacy layer in the opaque state and the display layer to display no image data, and a fourth mode in which the controller configures the privacy layer in the transparent state and the controls the display layer to display no image data.

19. The apparatus of claim 17, wherein the panel further comprises a touch screen layer communicatively coupled to the controller and disposed on the display layer to receive information from contact for controlling the display layer by the controller based at least in part upon the information received.

20. The apparatus of claim 17, wherein the panel further comprises a light guide layer that is disposed between the privacy layer and the display layer, and a light source optically coupled to the light guide layer to provide a controlled backlit region for the display layer.
